(19) United States
(12) Patent Application Publication
(10) Pub. No.: US 2015/0185855 A1
(43) Pub. Date: Jul. 2, 2015

(54) METHOD AND APPARATUS TO CONTINUOUSLY MAINTAIN USERS EYES FOCUSED ON AN ELECTRONIC DISPLAY WHEN EITHER ONE OR BOTH ARE MOVING

(71) Applicants: Ye Jin Hong, Woodbury, MN (US); Praveen Elak, Hartsdale, NY (US); Aparna Kumar Bansal, White Plains, NY (US); Shayak Banerjee, Hartsdale, NY (US)

(72) Inventors: Praveen Elak, Hartsdale, NY (US); Aparna Kumar Bansal, White Plains, NY (US); Shayak Banerjee, Hartsdale, NY (US); Ye Jin Hong, Woodbury, MN (US)

(73) Assignee: Praveen Elak, Hartsdale, NY (US)

(21) Appl. No.: 14/184,125

(22) Filed: Feb. 19, 2014

Related U.S. Application Data
(60) Provisional application No. 61/768,485, filed on Feb. 24, 2013.

(51) Int. Cl. G06F 3/01; G06F 3/0481

(52) U.S. Cl. CPC G06F 3/017; G06F 3/04815

(57) ABSTRACT

The present application relates to a method for continuously moving displayed information on an electronic display device according to the physical movement of a user so as to maintain the focus of the user's eyes on the content, and display apparatus thereof. By way of an example, this application will enable reading from an electronic display apparatus while the user and/or the display apparatus is in a dynamic environment, such as, while in a moving vehicle like car, train or bus and/or while working out in a cardiovascular machine like treadmills, elliptical machines, stairmasters, stepmills or stationary bikes.

The method described herein includes continuously detecting the physical movement of the user using either (i) motion sensors attached to the person, or (ii) a camera to continuously capture the image of the user's face and/or the image of an identifiable object attached to the user. The movement of the user, and subsequently his eyes, is determined from sensor data or by face recognition or by object detection. Simultaneously, measurement of the movement of the display device is performed using the sensors attached to or inside the display device. This allows determination of the relative movement between the user and the display device, which allows calculation of the amount of movement in the displayed information relative to the user. The displayed information is then moved by the same or relative amount in real time to continuously maintain the focus of the user's eyes on the text being read. The experience thereof is equivalent to a user reading in a stationary environment, such as, sitting on a couch and reading.

### FIELD OF THE INVENTION

The present invention relates to the electrical and electronic arts, and, more particularly to the methods and devices to continuously maintain same frame of reference between a user who is moving or a user who is inside a moving object and the text or images or like that the user is looking at.

### BACKGROUND OF THE INVENTION

Electronic displays are ubiquitous, with people spending increasing amounts of time on television, tablets, smartphones, e-readers or other handheld items. While such displays provide ease of reading or browsing media content through methods such as adjustable text size, backlighting, etc., they are yet to tackle one of the important human limitations—the difficulty in focusing on text or images when the human body is in motion relative to the text/images.

Normally, human beings are able to focus their eyes on a stationary object. If the object or the person is moving, it becomes difficult for humans to maintain focus on the said object. The difficulty in maintaining focus is dependent on the relative movement between the person and the object, the physical condition of the person and the nature of the object. The effect is especially pronounced for reading text. For example, if the object contains text, which the person is trying to read, or imagery, on which the person is trying to focus, it becomes difficult to concentrate.

The same effect applies to someone running on a treadmill, or exercising on an elliptical machine, or a similar machine where the user's head, and consequently his eyes, is moving while exercising. It becomes difficult to read or concentrate on the displayed information. The difficulty increases with the intensity of exercise, the smaller text and fast moving images. As another example, the same effect applies to someone traveling in a moving vehicle such as a car, bus or train. There can be several other cases where the person and/or the object are moving where an attempt is made to maintain the focus of the eyes on the information displayed.

### SUMMARY OF THE INVENTION

Principles of the invention provide methods and apparatus to continuously track the head movement and adjust displayed information accordingly to enable the eyes to maintain focus while the person and/or the object are moving. The object in this case can be any electronic reader such as a computer display or the phone display or the tablet display or some other device on which the text and images can be displayed electronically.

In one aspect, an exemplary method includes continuously tracking the person's physical movement relative to the display device, and the displayed information is moved accordingly to enable the user to maintain focus on the text being read. The tracking needs to be done in real time so that the person does not experience any lag or difficulty to focus. Alternatively, the method can include the use of predictive algorithms to determine the motion of the user or device ahead of time, and hence compensate for them ahead of time to further reduce the lag.

In another aspect, an exemplary apparatus set up includes the sensors to continuously track the person's physical movement by attaching it to a place on the human body. These sensors can be worn on head or neck or arm or shirt, put behind ears, clipped to the ear, or worn as glasses or on a belt or similar apparel. These sensors can be removable and can be attached to a person's body when needed. They continuously sense the head movement, directly or indirectly. An example of direct sensing is when the sensors are attached to the head. Indirect sensing includes compensation for other movements which may be necessary when the sensors are attached to other parts of the body. An example is when the sensors are attached to the neck, and the motion between the neck and head need to be accounted for. The head movement is detected and analyzed by a computation unit or a computer which can be attached to the sensors or the display device or it can be separate. This computation unit may use digital signal processing to filter and analyze the sensor data. The head movement data is computed and transmitted in real time (either from the sensor or the computer) to the display device via wire or wireless communication such as using Wi-Fi or Bluetooth or some other communication methods/protocols.

In another aspect, an exemplary method includes using a camera to continuously track the person's head movement. This camera can be attached to the device which is displaying the information, or it can be a standalone device. The camera will continuously capture the image of the person or the image of an identifiable object attached to the person, and send to a processing unit. This processing unit may use digital signal processing and/or utilize face detection algorithms to track the head movement. This processing unit can be integral part of the camera or the display device or it can also be a standalone device. Communication between camera, processing unit and display device may occur either through wired connection or wirelessly, via Wi-Fi, Bluetooth or other communication protocols.

As used herein, “information” includes the text, images or some other form of display which can be seen and interpreted using the human eyes. For the avoidance of doubt, this information can be anything which is displayed on an electronic display device. Also, as used herein, “continuous” implies that rate of tracking or capturing can be tens to million times a second, such that it practically seems continuous to the user.

One or more embodiments of the present invention may be realized in the form of an integrated circuit. One or more embodiments may use digital signal processing, object recognition or face detection.

These and other features and advantages of the present invention will become apparent from the following detailed description of illustrative embodiments thereof, which is to be read in connection with the accompanying drawings.

### BRIEF DESCRIPTION OF DRAWINGS

FIG. 1A shows a person reading from a display while the head and consequently, the eyes are physically moving up and down relative to the display.

FIG. 1B shows a person reading from a display while the head and consequently, the eyes are physically moving left and right relative to the display.

FIG. 1C shows a person reading from a display while the head and consequently, the eyes are physically moving toward and away from the display.

FIG. 2A shows a person reading from a display while the head is physically moving up and the information displayed on the display device is also moved upward in real time response so as to maintain the focus of the eyes on the displayed content.

FIG. 2B shows a person reading from a display while the head is physically moving down and the information displayed on the display device is also moved downward in real time response so as to maintain the focus of the eyes on the displayed content.

FIG. 2C shows a person reading from a display while the head is physically moving to the left and the information displayed on the display device is also moved to the left in real time response so as to maintain the focus of the eyes on the displayed content.

FIG. 2D shows a person reading from a display while the head is physically moving to the right and the information displayed on the display device is also moved to the right in real time response so as to maintain the focus of the eyes on the displayed content.

FIG. 3A shows a person reading from a display while the head is physically moving towards the display, and the size of displayed information is reduced in response, to maintain the focus of the eyes on the displayed content.

FIG. 3B shows a person reading from a display while the head is physically moving away from the display, and the size of displayed information is increased in response, to maintain the focus of the eyes on the displayed content.

FIG. 4 is an exemplary method to adjust the displayed information according to the physical movement of a person in the three-dimensional space by using the motion sensors attached to a person's body.

FIG. 5A is another exemplary method to adjust the displayed information according to the physical movement of the person where the motion of the head and the eyes is determined by using a camera which is continuously taking images of the person's body.

FIG. 5B is another exemplary method to adjust the displayed information according to the physical movement of the person where the motion of the head and the eyes is determined by using a camera which is continuously monitoring or taking images of a marker object attached to the body.

FIG. 6 shows a person reading from a display while both, the person and the display device are moving in the three-dimensional space.

FIG. 7A shows a person reading from a display while the person's head is moving up, while the display device is moving in three-dimensional space, and the information displayed on the display device is moved in real time so as to maintain the eye focus.

FIG. 7B shows a person reading from a display while the person's head is moving down, while the display device is moving in three-dimensional space, and the information displayed on the display device is moved in real time so as to maintain the eye focus.

FIG. 7C shows a person reading from a display while the person's head is moving to the left, while the display device is moving in three-dimensional space, and the information displayed on the display device is moved in real time so as to maintain the eye focus.

FIG. 7D shows a person reading from a display while the person's head is moving to the right, while the display device is moving in three-dimensional space, and the information displayed on the display device is moved in real time so as to maintain the eye focus.

FIG. 7E shows a person reading from a display while the person's head is moving toward the display, while the display device is moving in three-dimensional space, and the information displayed on the display device is moved in real time so as to maintain the eye focus.

FIG. 7F shows a person reading from a display while the person's head is moving away from the display, while the display device is moving in three-dimensional space, and the information displayed on the display device is moved in real time so as to maintain the eye focus.

FIG. 8 shows an exemplary method to adjust the information on the display according to the movements of the person and the display device where the motion sensors attached to a person's body and the display device are used to determine the motion.

FIG. 9A shows another exemplary method to adjust the information on the display according to the physical movements of the person and the display device where a camera is used to continuously capture the images of a person's body to determine the physical motion.

FIG. 9B shows another exemplary method to adjust the information on the display according to the physical movements of the person and the display device where a camera is used to continuously capture the images of a marker object attached to the person's body to determine the physical motion.

FIG. 10A shows, by way of example, the exemplary techniques to ensure that eyes are focused on the displayed information by controlling the sensitivity of the movement and the lag between the physical movement of the eyes and the physical movement of the displayed information when the head is moving upward

FIG. 10B shows, by way of example, the exemplary techniques to ensure that eyes are focused on the displayed information by controlling the sensitivity of the movement and the lag between the physical movement of the eyes and the physical movement of the displayed information when the head is moving downward.

### DETAILED DESCRIPTION OF PREFERRED EMBODIMENTS:

As noted above, it is difficult for an average person to focus on the information displayed on a display device if the person and/or the display device he is reading from are moving. The difficulty increases with the speed of movement.

Advantageously, one or more embodiments help a person to focus on the information displayed on a display device in the event of the movement of the person and/or the display device he is reading from.

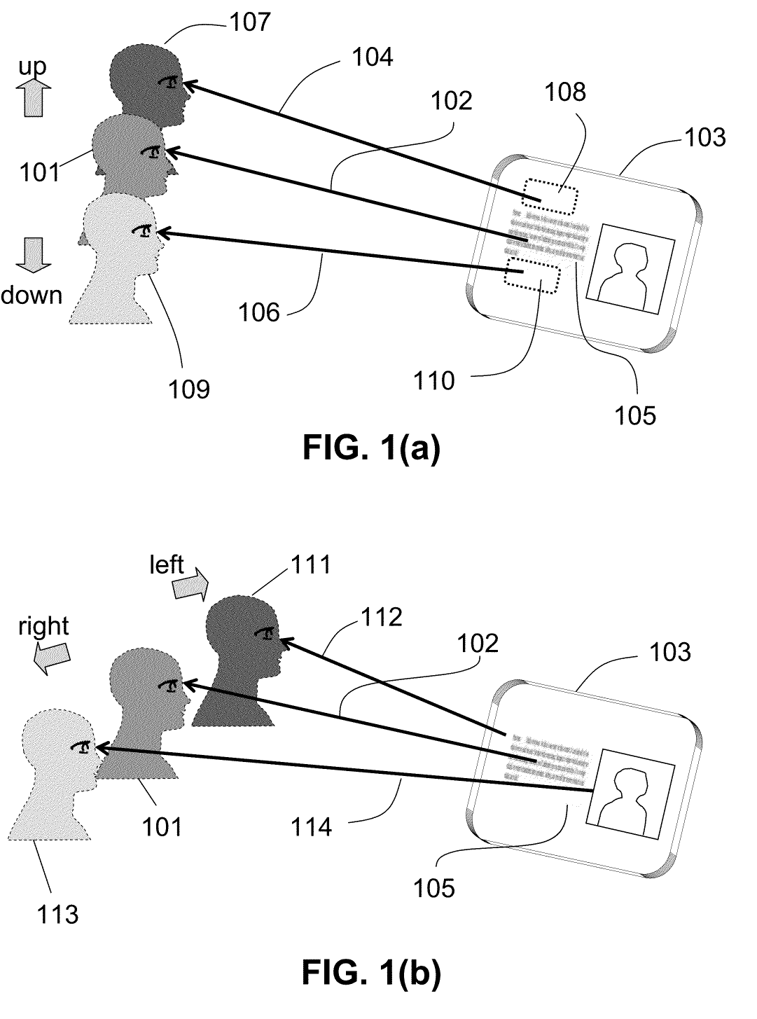

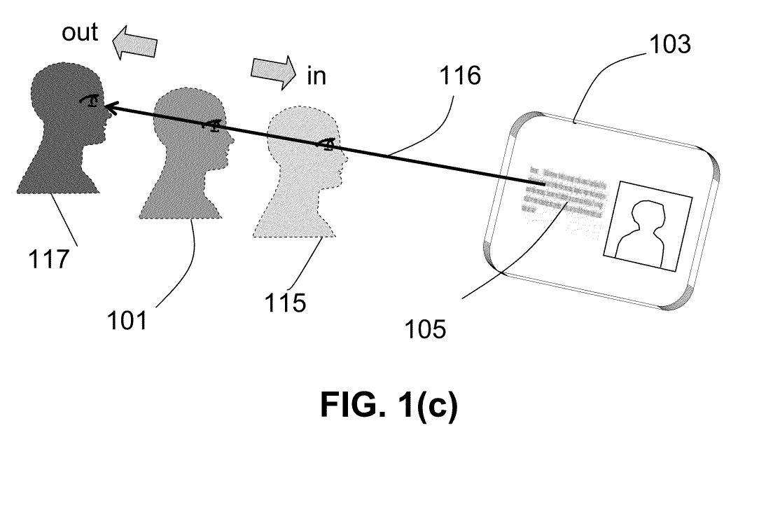

FIG. 1A shows 101 silhoutte of a person. 103 is the display device and 104 is the displayed information. Note that the displayed information can include text and/or images or some other form of visual information. If person (101) and the display device (103) are not moving, the arrow 102 represents the line of sight where eyes are focused on the information 105. The positions 107 (up) and 109 (down) of person represent the physical vertical movement of the head and the eyes. Line 104 represents the line of sight when eyes move up to 107. In that case, eyes expect the information at the position 108. Similarly, due to movement, if eyes move down to 109, the line of sight is 106 and eyes expect the information at the position 110. Eyes have the capability to readjust the focus line of sight to the displayed information if the movement is slow—from few hundreds of milli-seconds to a few seconds, depending upon a person's vision and cognitive abilities. If the movement is rapid such as in the following examples, but not limited to, cases such as while walking, running, traveling in a moving vehicle such as car, bus or train, while operating heavy machinery, while operating a vehicle on a rough terrain or while operating an airplane during turbulent conditions, the eyes move faster than they can readjust the focus. Hence, with the up-down movement of eyes, the lines of focus keep on moving and it becomes difficult for a person to maintain focus and grasp the information. One should note that the movement can be in any direction, left-right or up-down or in-out (towards or away from the display) or a combination of them. FIG. 1B shows a case where the movement is in left-right direction. The new eye positions 111 and 113 changes the line of sight or focus to 112 and 114, respectively. FIG. 1C shows a case where eyes (101) are moving towards (115) or away (117) from the display. In this case, the line of sight remains same, however, the distance between the eyes and the display changes. This scenario also makes it difficult to focus on the information because the displayed information such as text or images grow big in size when moving towards and look smaller when moving away.

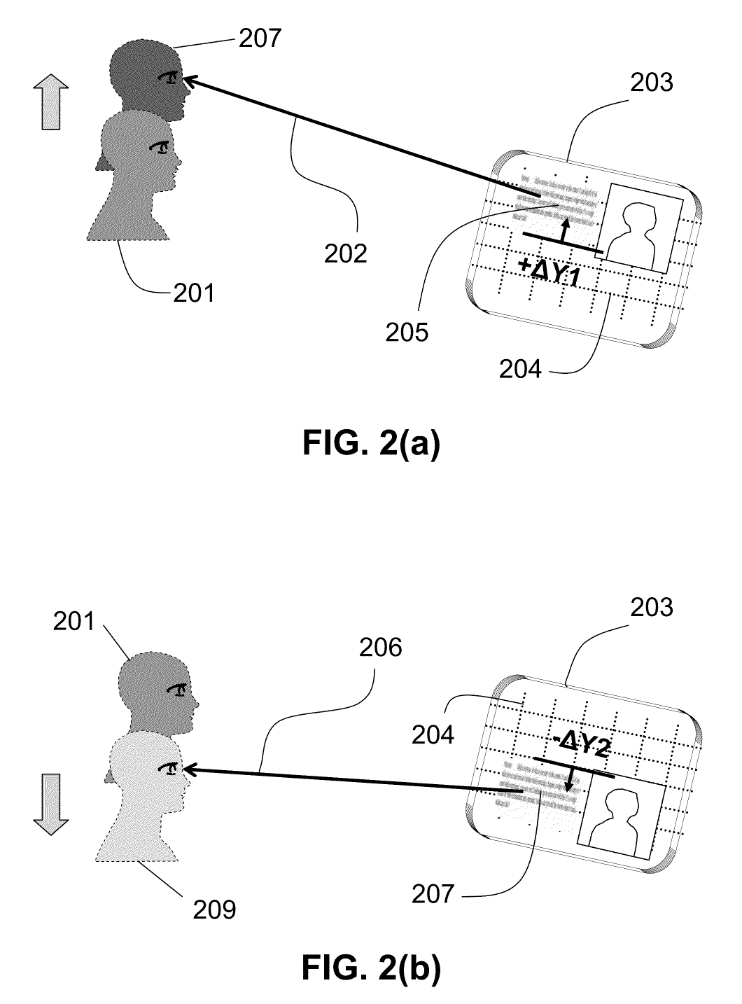

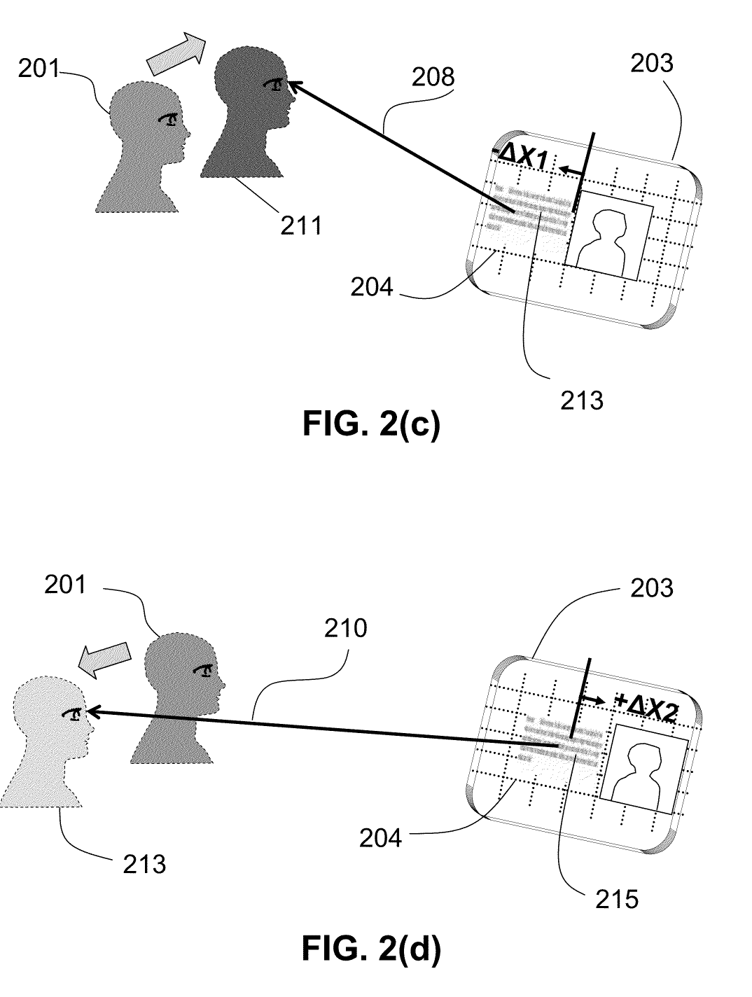

FIG. 2 shows a preferred embodiment which solves the problem of a person unable to read the displayed information while in motion. FIG. 2A shows 201 is a person and 203 is the display device he is reading from. If the person, and consequently his head and eyes physically move up to the position 207, the line of sight 202 moves up too. In this scenario, the displayed information 205 is also moved up by ΔY₁ representing vertical movement of the displayed information. The dotted grid lines 204 are for representation only to show the movement in the displayed information. FIG. 2B shows a scenario where person 201 moves down to the position 209. The line of sight is represented by 206. In this case, the displayed information 207 is moved down by ΔY₂. The movements of displayed information, ΔY₁ and ΔY₂ can vary from individual to individual depending on several factors such as quality of vision, reading speed, font type, distance from the display and the physical distance moved by the person and his eyes. The amount of movement of displayed information is tailored based on individual needs. Similar to the vertical movements, FIG. 2C and FIG. 2D shows a case where the person moves sideways. In FIG. 2C, as person's head and his eyes 201 move left to the position 211, the line of sight changes to 208 and the displayed information 213 is moved left by ΔX₁ on the display device 203. In FIG. 2D, if the person's head and his eyes 201 move right to the position 213, the line of sight is 210 and the displayed information 215 moves right by an amount ΔX₂. The movements of displayed information, ΔX₁ and ΔX₂ can vary from₁ individual to individual depending on several factors such as quality of vision, reading speed, font type, distance from the display and the physical distance moved by the person and his eyes.

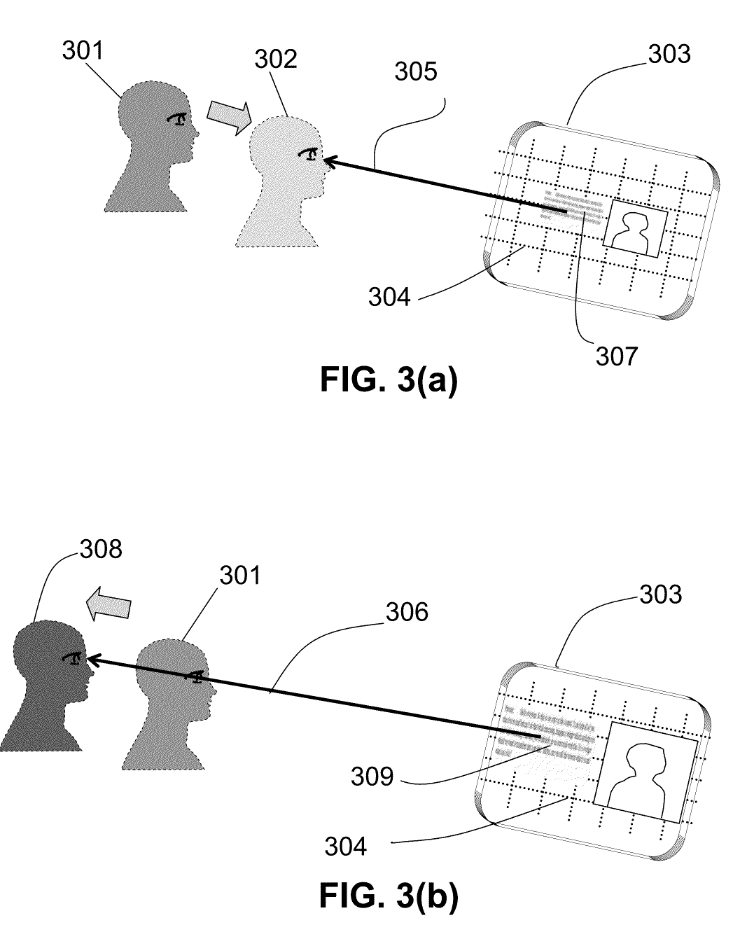

FIG. 3 shows another preferred embodiment which solves the problem of focusing a person's eyes on the displayed information when the person and consequently his eyes move towards or away from the display. In FIG. 3A, the person 301 move towards the display to the new position 302. The new line of sight 305 remains same. However, the distance between the person 302 and the display 303 is shorter now. Hence, the displayed information 307 is shrunk or reduced in size to help the eyes maintain focus. On the other hand, as in FIG. 3B, if the person 301 move away from the display to the new position 308, the displayed information 309 is magnified to help the eyes maintain focus. This reducing and increasing the size of the displayed information depends on several factors such as quality of vision, reading speed, font type, distance from the display and the physical distance moved by the person and his eyes. The amount of reduction or increase in the size of displayed information is tailored based on individual needs, and may be individually tuned by the observer using sensitivity and lag controls.

One would observe that the physical movement of the person can be in any direction in the three dimensional space. Hence, the displayed information is moved in the appropriate direction on the two-dimensional display as well as reduced or increased in size. If the displayed information itself is in three-dimensions, to maintain the eye focus while moving towards or away from the display, the information will not be reduced or increased in size; instead it will be moved towards or away from the eyes along the depth dimension.

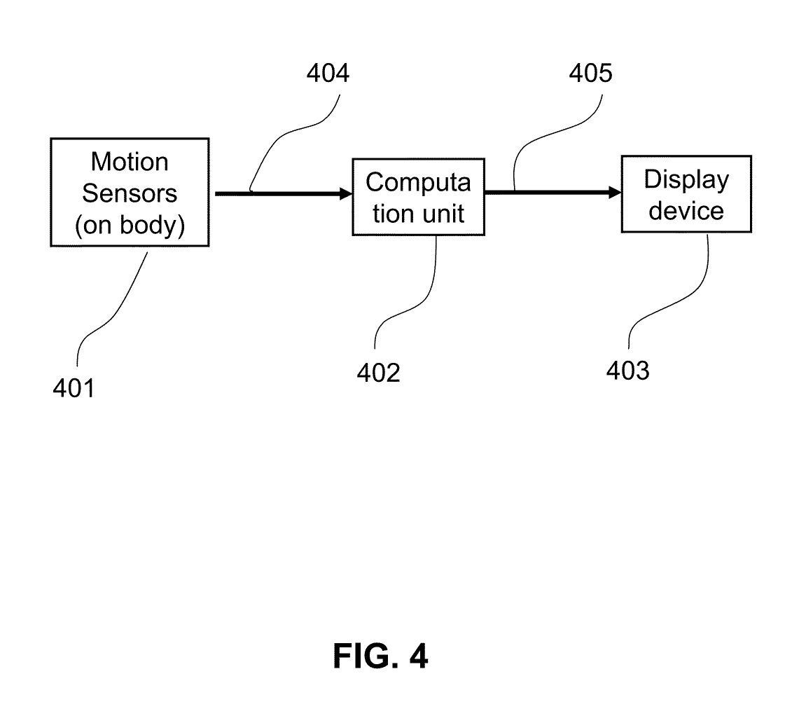

FIG. 4 shows a preferred embodiment to achieve the above solutions. 401 is a set of sensors which can detect the head movements. Assumption here is that human eyes are on a person's head and the physical movement of eyes needs to be measured. Individual motion sensors-accelerometer, gyroscopes and magnetometers, or any combination of these can be used to detect the motion. They can be used together or separately to detect the head movement. They are attached to the person's body so as to detect the eye movement. They can be attached anywhere on the head, neck, shoulders, arms, waist or any other body part whose movement could be directly or indirectly translated to the eye movement. The output of the sensors is sent to a 402 computation unit using communication 404 which can be either physical wire or wireless through medium of air. This 402 computation unit may use signal processing techniques to filter out the noise and drift from the sensor data. It can also do some other processing to determine the actual movement of the eyes. The computation unit may also control the sensitivity of the display response to motion, as well as intentionally introduce some lag between movement and display response. It may determine such sensitivity and lag parameters either automatically, using tuning algorithms, or allow the observer to tune them manually to improve the reading experience. Finally, computation unit sends this data to display device 403 using communication medium 405 which can be either physical wire or through the medium of air (wireless). Display device moves the information, as shown in FIG. 2 and FIG. 3, according to the eye movement to continuously maintain the focus. This movement is directly related to the movement of the eyes and is dependent on several factors, such as, distance between the eyes and the display, the font size if the information is text, resolution of the display, noise in the sensors, time lag in data processing and communication. The computation unit 402 can also be attached to either sensors 401 or the display device 403 or it can be separate.

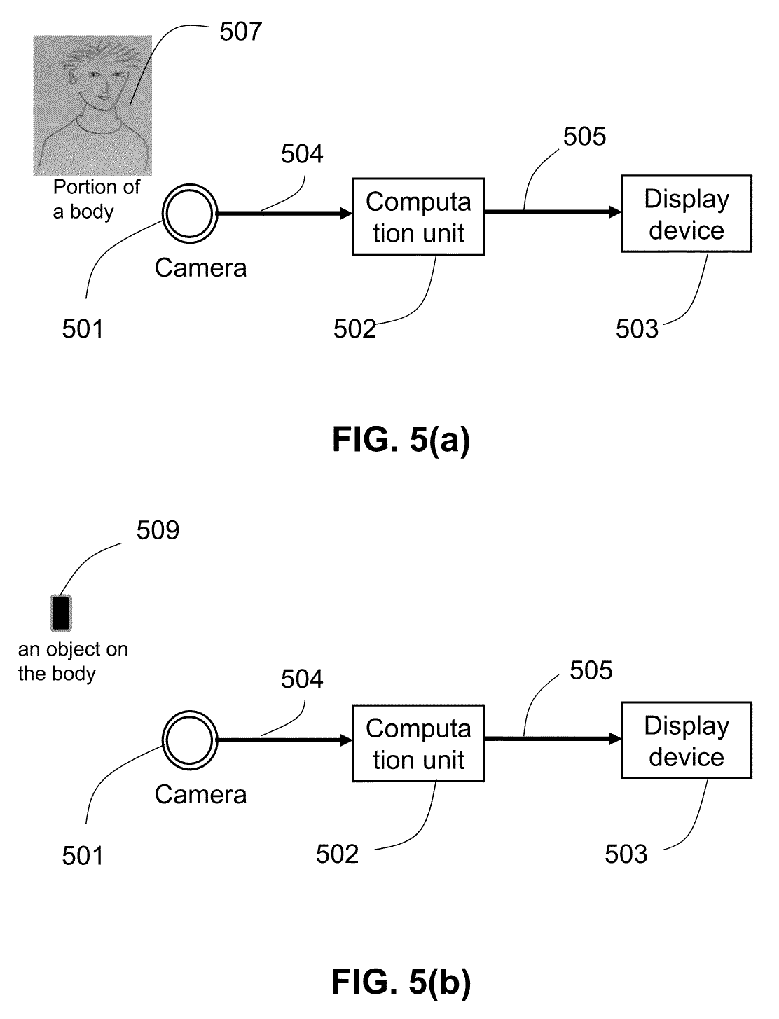

FIG. 5 shows another preferred embodiment where a camera 501 is used to determine the motion of the person. In FIG. 5A, the camera captures the images or video of the person's body or a portion of the body. 507 and surrounding area and sends it to a computation unit 502. This computation unit uses image processing techniques to compute the relative movement of the eyes compared to the surroundings and computes the relative movement in the displayed information in order for the eyes to maintain focus. Finally, this relative movement data is sent to the display device 503. The head movement data is transferred between the camera, the computation unit and the display device using 504 and 505, which can be either physical wired or wireless. The computation unit 502 can be attached to either the camera 501 or the display device 503 or it can be separate. Similar to taking video of the human body or a portion of it, as depicted in FIG. 5A, an object 509 can be attached to the person. This marker object 509 can be, but not limited to, for example, clip, pin, button etc. attached to the person. The camera captures the images or video of the user along with the marker object 509 and the computation unit 502 detects the movement of this object to determine the person's head movement. This exemplary method, advantageously, needs comparatively less computation effort, time and complexity, than image processing of a portion of the body and surroundings. One may decide to use a combination of sensors 401 and the camera 501 to accurately determine the motion.

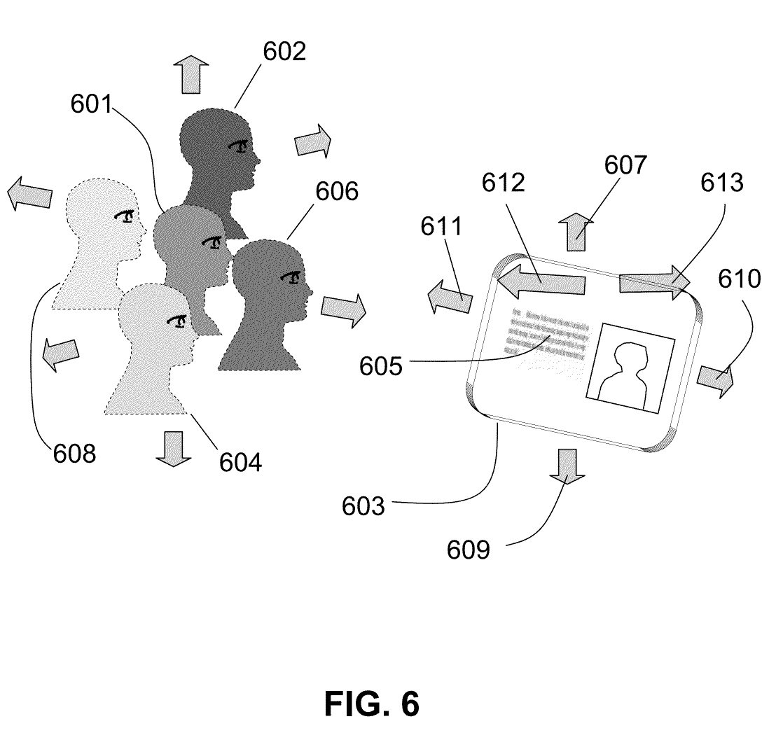

FIG. 6 shows another exemplary case where the head and the display device, both are moving. Their movement can or cannot be completely different from each other. 601 shows the person (and his eyes), 603 is the display device and 605 is the information displayed. The person 601 can physically move up 602 or down 604 or left 606 or right 608 or a combination of them. He can also move towards or away from the display but not shown here to make it easier to demonstrate the movement. The display device can also move up 607 or down 609 or left 610 or right 611 or towards the eyes 612 or away from the eyes 613 or a combination of them. The motion of the display device can be due to several factors, including but not limited to jerky motion while riding in a moving vehicle or while operating heavy machinery or some movement due to jerks in the treadmill or elliptical machines or voluntary or involuntary movement of the hands holding the display device.

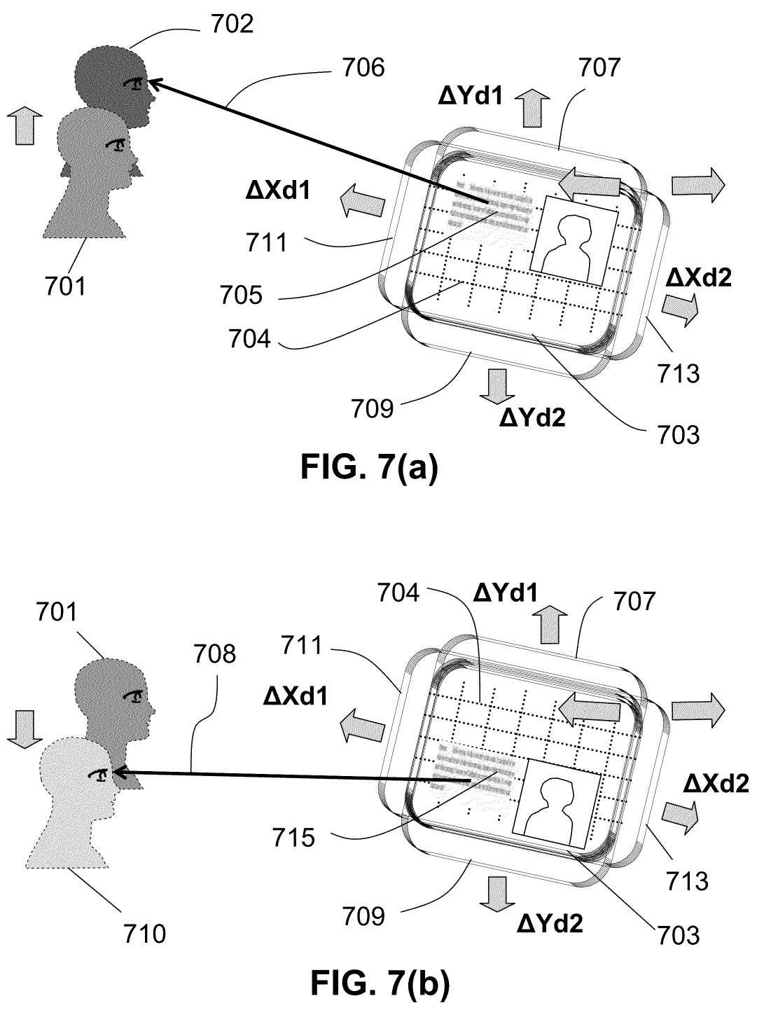

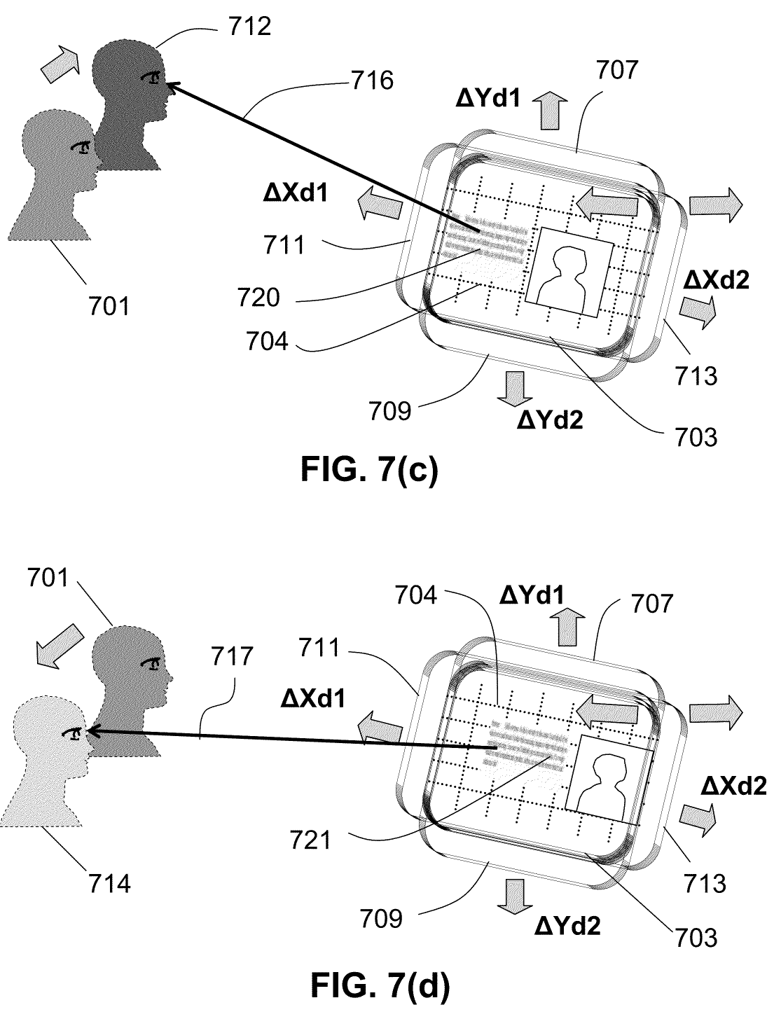

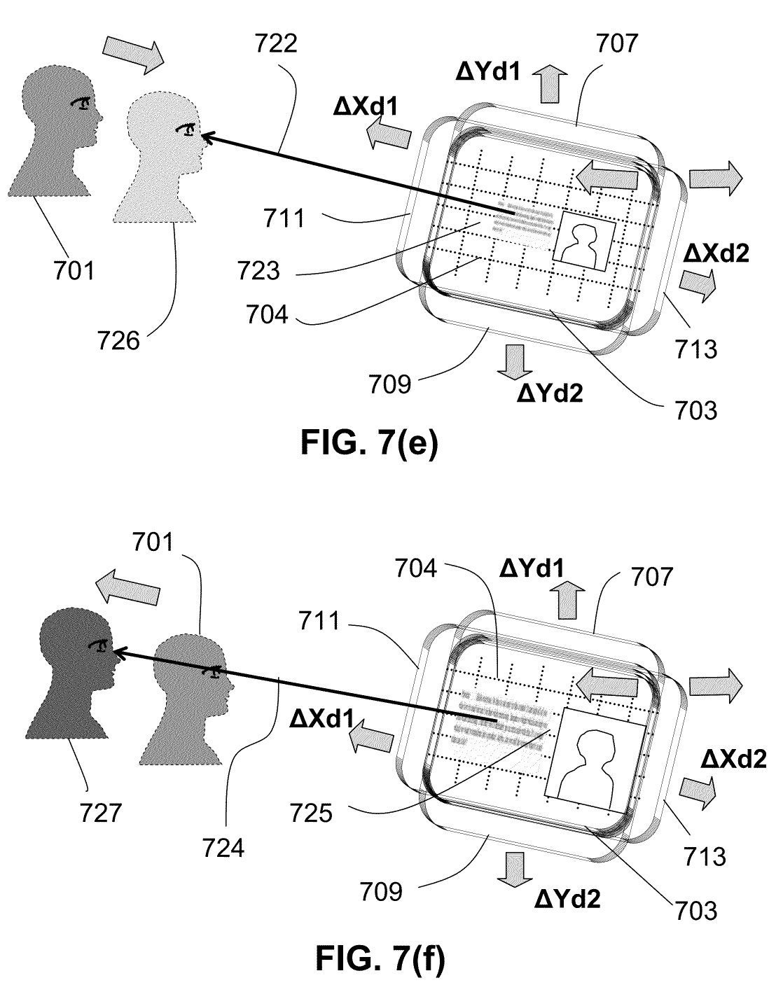

FIG. 7 shows an exemplary method to maintain eye focus on the displayed information when both the person and the display device are moving in three-dimensional space. In FIG. 7A, the person 701 move to the new position 702 thereby changing the line of sight to 706. Also the display device 703 can move up to 707 by ΔY_{d1} or down to 709 by ΔY_{d2} or left to 711 by ΔX_{d1} or right to 713 by ΔX_{d2} or a combination of them. It can also move towards the eyes or away from them as well. In this method, the displayed information 705 is motion compensated for any movement in the display as well as moved up as demonstrated in the method in FIG. 2A to fall in the line of sight 706. The grid lines 704 are for reference only to show the movement of displayed information. As an example of motion compensation of the displayed information to the movement in device display, if, for example, the display moves up by ΔY_{d1}, the displayed information needs to be moved down by ΔY_{d1}. As another example, if display moves left by ΔX_{d2}, the displayed information 705 is moved right by ΔX_{d2}. FIG. 7B shows the case where eyes 701 move down to the new position 710 and the line of sight changes to 708. In this case, the displayed information 715 is motion compensated for the movement in the display device as in FIG. 7A and then moved down to fall in the line of sight 708. In FIG. 7C, the person moves to the left to the position 712 and the line of sight changes to 716. In this case, the displayed information 720 is motion compensated for the motion in the display device 703 using the method described for FIG. 7A and also moved to the left. In FIG. 7D, the person 701 moves to the right to the position 714 and the line of sight changes to 717. In this case, the displayed information 721 is motion compensated for the motion in the display device 703 using the method described for FIG. 7A and also moved to the right. In FIG. 7E, the person 701 moves towards the display to the position 726. In this case, the displayed information 723 is motion compensated for the motion in the display device as described above for FIG. 7A and also shrunk in size as described in the method for FIG. 3A to maintain the eye focus. In FIG. 7F, the person 701 moves away from the display to the position 727. In this case, the displayed information 725 is motion compensated for the motion in the display device as described above for FIG. 7A and also increased in size as described in the method for FIG. 3B to maintain the eye focus.

One would observe that the display device 703 can also move towards the person or away from them. In that exemplary case, to compensate for the motion of display device, the displayed information is reduced in size when the display device moves towards the person, or increased in size to compensate for the display device moving away from the eyes. In another exemplary case of three-dimensional display device, instead of increasing or reducing the size of the displayed information as the distance between the display device and the person increases or reduces, respectively, the displayed information will be moved towards or away from the eyes. One would also note that the movement and change in size of the displayed information includes the motion compensation of the display device and the physical movement of the eyes.

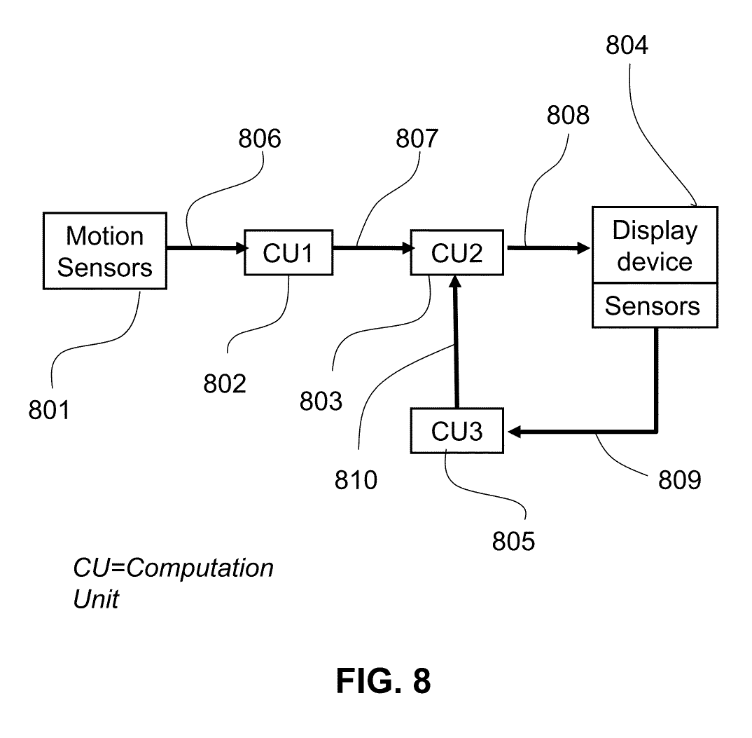

FIG. 8 shows a preferred embodiment where the problem shown in FIG. 7 is solved. 801 is a set of sensors which can detect the head movement. The assumption here is that human eyes are on a person's head and the physical movement of eyes needs to be measured. Any individual motion sensor—accelerometer, gyroscope, magnetometer—or any combination of the same can be used to detect the motion. They can be used together or separately to detect the head movement. They are attached to the person's body so as to detect the physical movement of the attached body part and translate that to the movements in the eyes. They can be attached anywhere on the head, neck, shoulders, waist or any other body part whose movement can be used to estimate or measure the movement of the eyes. The output of the sensors is sent to a first computation unit CU1 shown as 802. This computation unit may use signal processing techniques to perform some calculations on the sensor data, and filter out the noise and drift (Eq. 1).

H(x,y,z,t)=CU₁(s₁, s₂, . . . , sₙ, t) (1)

In the above equation, H represents the motion vectors of the eyes at time t. This can be information such as displacement, acceleration or velocity along the chosen set of orthogonal axes. Each sensor utilized is represented by sᵢ, where n is the total number of sensors utilized.

Another set of motion sensors are attached to the display device 804. These sensors can be integrated inside the display device or attached outside. The display device motion sensor data from 804 is sent to another computation unit CU3 shown as 805. The CU3 does some calculations on the sensor data such as filtering out the noise and the drift. CU3 may also perform computation of motion vectors of the display device (Eq. 2), along with optional translation of such motion vectors to an alternate frame of reference.

D(x,y,z,t)=CU₃(s₁, s₂, . . . , sₘ,t) (2)

In the above equation, D represents the motion vectors of the display device at time t. This can be information such as displacement, acceleration or velocity along the chosen set of orthogonal axes. Each sensor utilized is represented by sᵢ, where m is the total number of sensors utilized.

The outputs of CU1 and CU3 are sent to another computation unit CU2 shown as 603. The CU2 combines the eye movement data from CU1 and display device movement data from CU3 to compute the required actual movement in the information displayed on the device to maintain the focus, and sends it to the display device 804 (Eq. 3).

ΔX_{d}(t)=CU₂(H, D, Sₓ, t_{L}) (3.1)

ΔY_{d}(t)=CU₂(H, D, S_{y}, t_{L}) (3.2)

ΔZ_{d}(t)=CU₂(H, D, S_{z}, t_{L}) (3.3)

In the above equation, ΔX_{d}, ΔY_{d} and ΔZ_{d} represent the necessary amount of displacement of the display along its x, y and z axes respectively. Sₓ, S_{y} and S_{z} represent sensitivity parameters which determine the magnitude of displacement per unit of eye motion. t_{L} represents any additional delay introduced between the eye motion and the displacement of the display. Sₓ, S_{y}, S_{z} and t_{L}, may be user supplied parameters or automatically determined using tuning algorithms. H and D are the previously determined eye and displace device movement information respectively.

Display device moves the information according to the physical movement of the person and his eyes to maintain the focus. This movement is directly related to the movement of the eyes and is dependent on several factors, such as, distance between the eyes and the display, the relative movement between the eyes and the display device, the font size if the information is text, resolution of the display, noise in the sensors, time lag in data processing and communication. The head motion data is transferred between the sensors, computation units and the display device using communication channels 806, 807, 808, 809 and 810. These channels can be physical wire or wireless. The one or more computation units can be attached to either sensors or the display device or they can be separate.

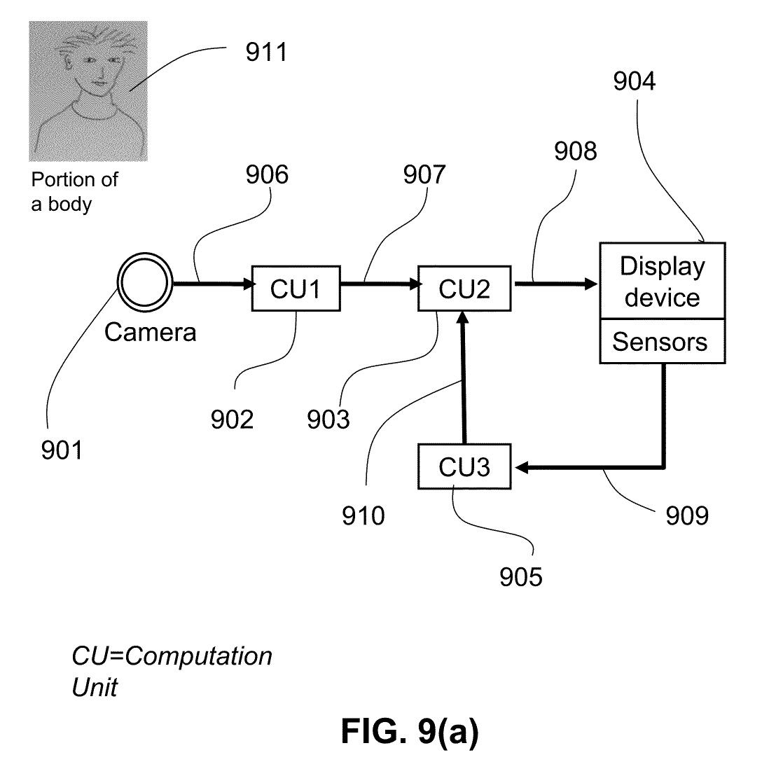

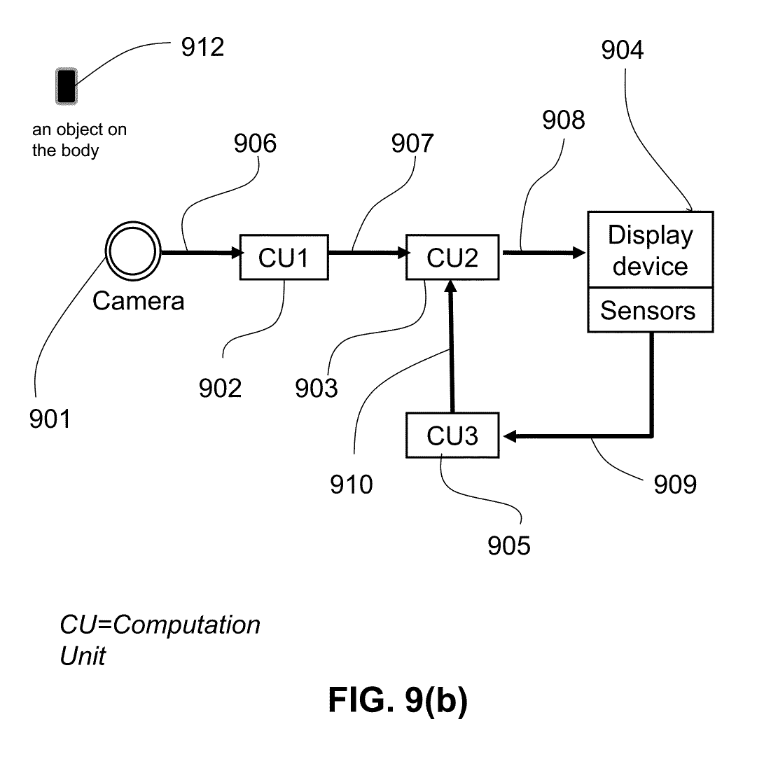

FIG. 9A shows another preferred embodiment which replaces sensors attached to the person's body 801 by a camera 901. The camera continuously captures the images or video of the person's head or body or a portion of the body 911 and the surrounding area and sends it to a first computation unit CU1 shown as 902. This unit may use image processing techniques such as object and face recognition to compute the relative movement of the eyes compared to the surroundings. The computation function form is similar to Eq. 1, where s₁, s₂, . . . sₙ represent different images captured by the camera, which are used to compute the motion vectors. Another set of similar sensors are attached to the display device 904. These sensors can be integrated inside the display device or attached outside. The sensor data from 904 is sent to another computation unit CU3 shown as 905. The CU3 does some calculations on the sensor data such as filtering out the noise and the drift. CU3 may also perform computation of motion vectors of the display device (Eq. 2), along with optional translation of such motion vectors to an alternate frame of reference.The outputs of CU1 and CU3 are sent to another computation unit CU2 shown as 903. The CU2 combines the eye movement data from CU1 and display device movement data from CU3 to compute the required actual movement in the information (Eq. 3) displayed on the device to maintain the focus, and sends it to the display device 904. Display device moves the information according to the eye movement to maintain the focus. This movement is directly related to the movement of the eyes and is dependent on several factors, such as, distance between the eyes and the display, the relative movement between the eyes and the display device, the font size if the information is text, resolution of the display, noise in the sensors, time lag in data processing and communication. The head tracking data is transferred between sensors, computation units and the display device using communication channels 906, 907, 908, 909 and 910. These channels can be physical wired or wireless. The one or more computation units can be attached to either sensors or the display device or they can be separate.

In FIG. 9B a marker object 912 for example, clip, pin, button etc. is attached to the person. The camera captures the image of the user along with the object and the computation unit CU1 902 detects the movement of this object to determine the person's head movement. This exemplary method, advantageously, needs comparatively less computation effort, time and complexity, than determining the motion of the person's body or a portion of it. One may decide to use the combination of exemplary methods shown in FIG. 8 and FIG. 9 to accurately estimate or measure the motion of the eyes.

Referring to FIG. 9A and 9B, it should be noted that the sensors attached to the display may not be needed if camera is attached to the display because it will move together with the display and capture the relative motion.

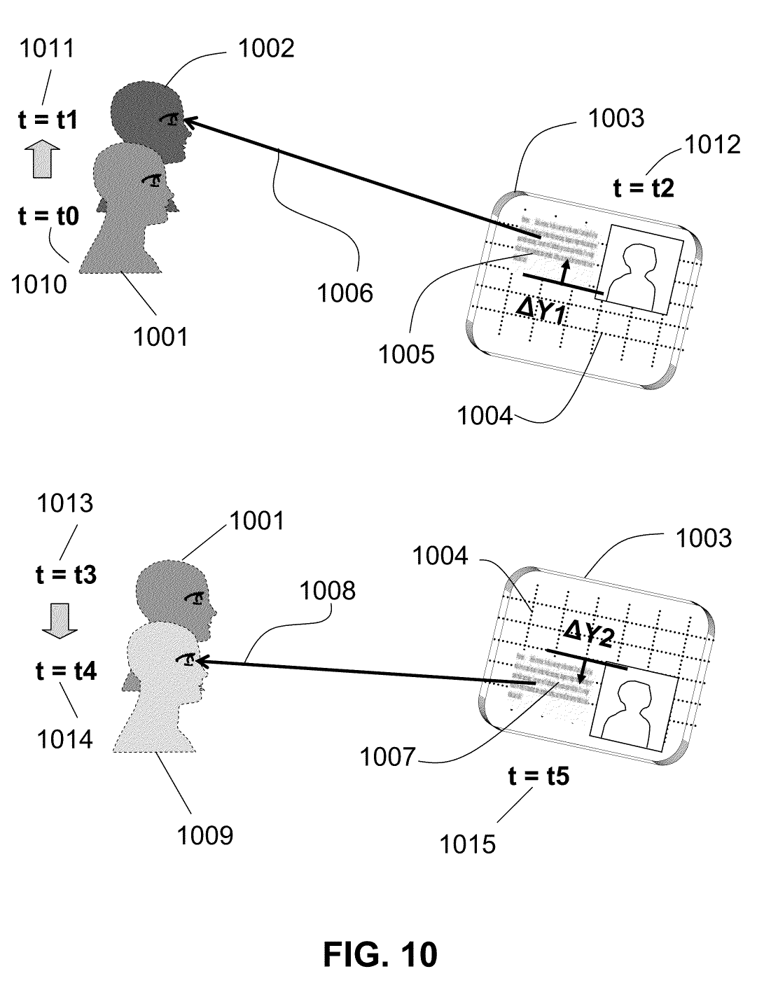

FIG. 10A shows, by way of example, the exemplary techniques to ensure that eyes are focused on the displayed information by controlling the sensitivity of the movement and the lag between the physical movement of the eyes and the physical movement of the displayed information. The eyes are at the location 1001 at time t₀, represented as t=t₀ and marked 1010. The eyes move to the location 1002 at time t₁ marked 1011. That modifies the line of sight to 1006. The displayed information 1005 is moved up by the distance ΔY at time t₂ marked as 1012. The movements of displayed information ΔY₁ can vary from individual to individual depending on several factors such as quality of vision, reading speed, displayed content, font type, display resolution, distance from the display and the physical distance moved by the eyes. The amount of movement of displayed information is tailored based on the individual needs. Further, one versed in the art would notice that the time difference between t₁ and t₂ has to be small (in milli-second to tens of milli-seconds) in order that there be no perceivable lag in the motion of the display. One would assume that time t₂>t₁ by the time it takes to determine the motion, filter out the noise and move the displayed information. One of the exemplary methods to reduce this time difference between the movement of the eyes and the movement of the displayed information constitutes the use of prediction algorithms. These algorithms monitor the previous motion information and, advantageously, move the displayed information to the estimated location (Eq. 4).

ΔX_{d}(t)=CU₂(Hₜ₋₁, Hₜ₋₂, . . . H_{t-N}, Dₜ₋₁, Dₜ₋₂, . . . D_{t-M}, Sₓ, t_{L}) (4.1)

ΔY_{d}(t)=CU₂(Hₜ₋₁, Hₜ₋₂, . . . H_{t-N}, Dₜ₋₁, Dₜ₋₂, . . . D_{t-M}, S_{y}, t_{L}) (4.2)

ΔZ_{d}(t)=CU₂(Hₜ₋₁, Hₜ₋₂, . . . H_{t-N}, Dₜ₋₁, Dₜ₋₂, . . . D_{t-M}, S_{z}, t_{L}) (4.3)

In the above equation, ΔX_{d}, ΔY_{d} and ΔZ_{d} represent the necessary amount of displacement of the display along its x, y and z axes respectively. Sₓ, S_{y} and S_{z}represent sensitivity parameters which determine the magnitude of displacement per unit of eye motion. t_{L}, represents any additional delay introduced between the eye motion and the displacement of the display. Sₓ, S_{y}, S_{z} and t_{L}, may be user supplied parameters or automatically determined using tuning algorithms. (Hₜ₋₁, Hₜ₋₂ . . . , H_{t-N}) are the head movement data detected at previous N time samples, while (Dₜ₋₁, Dₜ₋₂ . . . , D_{t-N}) represent device movementinformation respectively at previous M time samples. As will be evident to one skilled in the art, these previous samples are used in a prediction algorithm to determine the current displacement of the display along the different axes.

Thus one can achieve time t₁=t₂ or even time t₂<t₁. Now, as shown in FIG. 10B, if the eyes at the location 1001 at time t₃ marked as 1013 are moved down to the location 1009 at time t₄ marked as 1014, the displayed information 1007 is moved down by ΔY₂ at time t₅ marked as 1015. Using the similar prediction algorithms as mentioned above for describing FIG. 10A, the time difference between t₄ and t₅ can be minimized and even made t₅<=t₄. These prediction algorithms can advantageously, further smooth the movement of the displayed information to provide a better experience to the user. These examples in FIGS. 10A and 10B are extended to other cases shown in FIG. 2, FIG. 3 and FIG. 7.

As an exemplary inclusion, display device can be either one, two or three-dimensional. It can be a computer screen or a television screen or a phone display or a tablet display or advertising boards or projected image. The projected image can be projected from a projector attached to a person's body or the projector can be a separate unit.

1. A sensing apparatus, comprising:
a clip on device attached to the body of the user to generate information on physical movement of the user, or
a front facing camera mounted on the display apparatus to track and generate information on the user's physical movement

2. A second sensing apparatus, comprising:
a motion sensor attached to or inside the display apparatus to generate information on the physical movement of the display apparatus

3. In pursuant to claims 1 and 2, a software-implemented method that moves the text and/or images displayed on or projected by the display apparatus in real time, either through actual or predicted information from claims 1 and/or 2, to compensate for the physical movement of the user and/or the physical movement of the display apparatus

4. Any application or a system thereof that uses sensing apparatus described in claims 1 and/or 2 to detect all 3D motion of a person or/an object, along with the software-implemented method described in claim 3 to compensate for the motion while there is no line of sight
